(19) United States
(12) Patent Application Publication
(10) Pub. No.: US 2006/0190831 A1
(43) Pub. Date: Aug. 24, 2006

(54) System and method for delaying pop-up window

(76) Inventors: Scott Edwards Kelso, Durham, NC (US); John Carl Mese, Cary, NC (US); Nathan J. Peterson, Raleigh, NC (US); Rod David Waltermann, Rougemont, NC (US); Arnold S. Weksler, Raleigh, NC (US)

Correspondence Address: ROGITZ & ASSOCIATES, 750 B STREET, SUITE 3120, SAN DIEGO, CA, 92101, US

(21) Appl. No.: 11/063,093

(22) Filed: Feb. 22, 2005

(51) Int. Cl. G06F 9/00

(52) U.S. Cl. 715/764; 715/808; 715/783

(57) ABSTRACT

Automatic display of a pop-up window on a computer is delayed until a time period has elapsed since the last user keyboard entry or mouse manipulation, to avoid distracting the user while the user is busy inputting data.

### FIELD OF THE INVENTION The present invention relates generally to the display of pop-up windows on computers.

### BACKGROUND OF THE INVENTION

A common problem with computer operating systems is that while typing in one window, another window (generated by the operating system or by an application running on the operating system) pops up and distracts the user's attention. This second window is called a pop-up window or simply pop-up. If the pop-up is just an informational dialogue box, the window occasionally gets closed immediately due to subsequent typing in the first window, but until it does, it remains a distraction. And, the pop-up window remains hidden until such time as the user remembers to open it.

Another problem that occurs from a pop-up event is it interrupts drag and drop operations. Some applications have a setting to turn off pop-ups that would come to the front and steal focus. Currently, however, there is no method to delay, as opposed to simply preventing, display of a pop-up until such time as is convenient for the user.

### SUMMARY OF THE INVENTION

A method is disclosed for controlling the display of pop-up windows. The method includes receiving a pop-up window signal from a computer operating system or from a computer application, and before initially presenting a pop-up window associated with the pop-up window signal, determining whether a current usage criterion is satisfied. If the current usage criterion is satisfied, the pop-up window is not displayed, but otherwise it is.

The current usage criterion can be keyboard input having occurred within a previous time period measured from the time of receiving or generating the pop-up window signal. Also, the current usage criterion may be manipulation of a point-and-click device having occurred within the previous time period. The time period may be, e.g., greater than zero seconds and less than sixty seconds or some other positive time period, and may be dynamically established based on a data input rate or directly by user selection.

In another aspect, a computer system has a processor executing an operating system and one or more applications executable by the processor. Logic is executable by the processor for delaying presentation of a pop-up window until user input signals have not been received by the system for a threshold period of time, after the elapse of which the pop-up window is automatically displayed.

In yet another aspect, a computer program product includes means for detecting a pop-up event. The pop-up event is for triggering the automatic display of a pop-up window on a computer. Means are provided for determining whether user input has occurred within a non-zero time period prior to a time related to the pop-up event, and means delay the automatic display of the pop-up window if user input has occurred within the non-zero time period.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system;

FIG. 2 is a flow chart of a first non-limiting embodiment of the present logic; and

FIG. 3 is a flow chart of a second non-limiting embodiment of the present logic.

### DETAILED DESCRIPTION OF THE PREFERRED EMBODIMENT

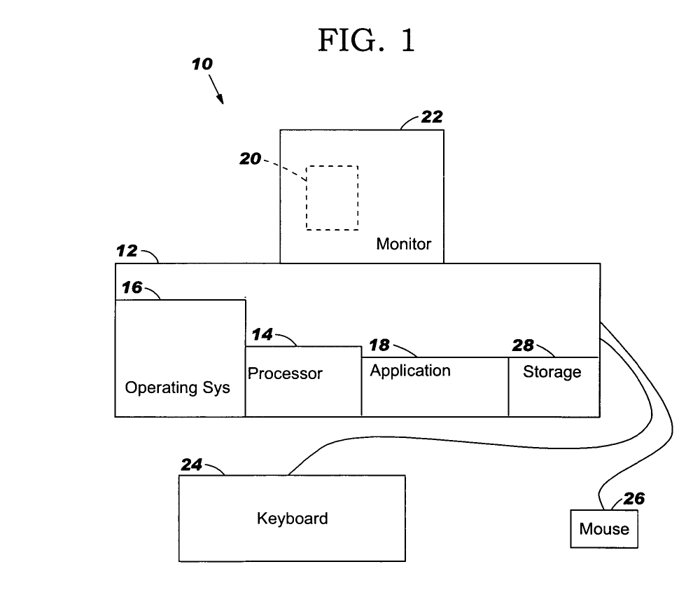

Initially referring to FIG. 1, a system is shown, generally designated 10, including a computer 12 that includes a processor 14 running an operating system 16 and one or more software applications 18. One or both of the operating system 16 and application 18 may from time to time generate a pop-up event that entails displaying a pop-up 20 on a monitor 22 that is associated with the computer 12. The computer 12 also has one or more input devices such as but not limited to a keyboard 24 and a point-and-click device such as a mouse 26 that can be manipulated by a user to input data to the processor 14. It is to be understood that output devices other than the monitor 22, such as audio speakers, printers, other computers, etc. may be used and controlled herein for pop-up presentation as set forth below. Also, input devices other than the keyboard 24 and mouse 26, such as voice input devices, trackballs, etc., may be used to determine user activity in accordance with principles below. A data storage 28, such as but not limited to solid state memory, floppy diskette memory, hard disk drive or optical memory, and the like may be provided for containing the below logic.

In exemplary non-limiting implementations set forth further below, the system 10, after receiving a pop-up signal, determines whether or not the user is busy as indicated by the user inputting a signal via typing through the keyboard 24 and/or mouse 26 within a predetermined time period, before displaying the pop-up 20. If the operating system 16 has not received a signal from the keyboard 24 or the mouse 26 in the given number of seconds, then the pop-up 20 is displayed on the monitor 22.

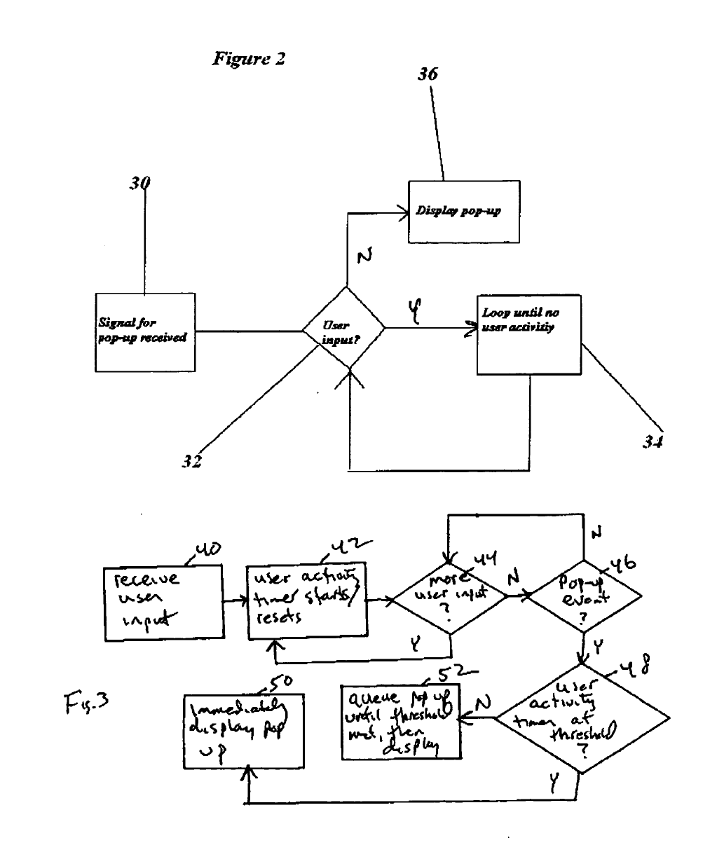

Now referring to FIG. 2, at block 30 a pop-up signal indicating the generation of a pop-up event is received from a source such as the operating system 16 or application 18. At decision diamond 32 the operating system 16, in response to receiving the pop-up signal, checks whether or not input by the user, sent either through the keyboard 24 and/or the mouse 26 and/or other input device, has been received by the operating system within a predetermined time period prior to the generation of the pop-up signal. The predetermined time period may be zero seconds, or it may be some finite period greater than zero seconds, e.g., twenty seconds, sixty seconds, or five seconds. To illustrate using the latter non-limiting example, if no user input has been received in the five seconds prior to receiving the pop-up signal, the test at decision diamond 32 is negative, but if the user had input data in the five seconds prior to the pop-up signal, the test is positive. In some implementations the time period may be dynamically established, e.g., when slower typing speeds or other data input speeds are sensed, the time period may be relatively long, whereas for faster input rates the time period may be shortened. Other heuristics may be used to establish the time period, e.g., allowing a user to specify the time period.

FIG. 2 thus shows that this process of the operating system checking the input within the predetermined number of seconds previous to receiving the signal for the pop-up message is represented by decision diamond 32. If the user had input any signal through either a keyboard or a mouse (or other input device as desired), the logic moves to block 34, wherein the operating system loops as shown until a negative test is obtained at decision diamond 32. When a negative result occurs at decision diamond 32, the operating system displays the pop-up window associated with the pop-up signal at block 36.

FIG. 3 shows alternate logic that begins at block 40 when user input is received. This starts a user activity timer at block 42. The user activity timer can count up to a threshold or down to zero from a positive time value.

In any case, the logic moves to decision diamond 44 to determine whether more user input is being received, and if so loops back to block 42 to reset the timer. However, in the non-limiting flow chart format shown the negative test at decision diamond 44 indicates that the logic can flow to decision diamond 46 to determine whether a pop-up event is received, and if not loops back to decision diamond 44.

When a pop-up event is received, however, the logic moves from decision diamond 46 to decision diamond 48 to test whether the user activity timer is at a threshold, e.g., at a predetermined positive number for counters that count up or at zero for counters that count down. Recall that the threshold may be set by the user or based on data input rate or may remain constant. In any case, when the user activity timer is at (or beyond) the threshold, the pop-up is immediately displayed at block 50. Otherwise, it is queued at block 52, potentially with other pop-ups, until such time as the user activity threshold reaches the threshold, at which point the pop-ups are displayed, if desired in order of receipt or in order of importance or in some other order. The previously queued pop-ups may be displayed at once in respective portions of the screen, or overlaid on each other on the display, or may be displayed individually in temporal sequence, each for a predefined period.

It is to be understood that while for ease of exposition FIGS. 2 and 3 are cast in flow chart format showing loops, the present logic may be implemented by event-driven code or other equivalent programming.

While the particular SYSTEM AND METHOD FOR DELAYING POP-UP WINDOW as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method for controlling the display of pop-up windows, comprising:
receiving a pop-up window signal from at least one of: a computer operating system, and a computer application;
before initially presenting a pop-up window associated with the pop-up window signal, determining whether at least one current usage criterion is satisfied; and
if the current usage criterion is satisfied, not displaying the pop-up window, and otherwise displaying the pop-up window.

2. The method of claim 1, wherein the current usage criterion is keyboard input having occurred within a previous time period measured from at least one of: the time of the receiving act, and the time the pop-up window signal was generated.

3. The method of claim 1, wherein the current usage criterion is manipulation of a point-and-click device having occurred within a previous time period measured from at least one of: the time of the receiving act, and the time the pop-up window signal was generated.

4. The method of claim 1, wherein the current usage criterion is data input within a time period prior to the pop-up window signal being received or generated, the time period being a period greater than zero seconds and less than “n” seconds, wherein “n” is a positive number.

5. The method of claim 1, wherein the pop-up window signal is generated by an application running on the operating system.

6. The method of claim 1, wherein the pop-up window signal is generated by the operating system.

7. The method of claim 1, wherein the usage criterion is established based at least in part on at least one of: a data input rate, and a user selection.

8. A computer system, comprising:
a processor executing an operating system;
at least one application executable by the processor; and
logic executable by the processor for delaying presentation of a pop-up window until user input signals have not been received by the system for a threshold period of time, after the elapse of which the pop-up window is automatically displayed.

9. The system of claim 8, wherein the logic delays presentation of the pop-up window if keyboard input has occurred within a previous time period measured from the time a pop-up window signal associated with the pop-up window was sensed by the operating system.

10. The system of claim 8, wherein the logic delays presentation of the pop-up window if input from a point-and-click device has occurred within a previous time period measured from the time a pop-up window signal associated with the pop-up window was sensed by the operating system.

11. The system of claim 8, wherein the pop-up window is generated by the application.

12. The system of claim 8, wherein the pop-up window is generated by the operating system.

13. The system of claim 8, wherein the time period is established based at least in part on a data input rate.

14. A computer program product, comprising:
means for detecting a pop-up event, the pop-up event for triggering automatic display of a pop-up window on a computer;
means for determining whether user input has occurred within a non-zero time period prior to a time related to the pop-up event; and
means for delaying the automatic display of the pop-up window if user input has occurred within the non-zero time period.

15. The computer program product of claim 14, wherein the user input is keyboard input.

16. The computer program product of claim 14, wherein the user input is point-and-click device input.

17. The computer program product of claim 14, wherein the pop-up window event is generated by an application running on the operating system.

18. The computer program product of claim 14, wherein the pop-up window event is generated by the operating system.

19. The computer program product of claim 14, wherein the time period is established by user selection.
